(19) United States
(12) Patent Application Publication
(10) Pub. No.: US 2007/0141317 A1
(43) Pub. Date: Jun. 21, 2007

(54) Wood composite material containing albizzia

(76) Inventor: Nianhua Ou, Dacula, GA (US)

Correspondence Address: Carlos Nieves, Esq.;J.M. Huber Corporation, 333 Thornall Street, Edison, NJ, 08837-2220, US

(21) Appl. No.: 11/300,810

(22) Filed: Dec. 15, 2005

(51) Int. Cl. B32B 21/02

(52) U.S. Cl. 428/292.4

(57) ABSTRACT

Disclosed is a wood composite board comprising albizzia strands.

### BACKGROUND OF THE INVENTION

Wood is a common material used to construct doors and other architectural building elements. Even today, after the development of several new species of composite materials, wood remains one of the most widely-used structural materials because of its excellent strength and stiffness, pleasing aesthetics, good insulation properties and easy workability.

However, in recent years the cost of solid timber wood has increased dramatically as its supply shrinks due to the gradual depletion of old-growth and virgin forests. It is particularly expensive to manufacture doors from such material because typically less than half of harvested timber wood is converted to natural solid wood lumber, the remainder being discarded as scrap.

Accordingly, because of both the cost of high-grade timber wood as well as a heightened emphasis on conserving natural resources, wood-based alternatives to natural solid wood lumber have been developed that make more efficient use of harvested wood and reduce the amount of wood discarded as scrap. Plywood, particle board and oriented strand board (“OSB”) are examples of wood-based composite alternatives to natural solid wood lumber that have replaced natural solid wood lumber in many structural applications in the last seventy-five years. These wood-based composites not only use the available supply of timber wood more efficiently, but they can also be formed from lower-grade wood species, and even from wood wastes.

However, the wood composite boards have a disadvantage in that they tend to have a very high density; for example, at least about 38 lbs per cubic foot (“pcf”) for OSB made out of aspen wood, while OSB typically has a density in excess of 42 pcf for pine wood. This makes wood composites like OSB not only excessively heavy for workmen installing it in typical OSB applications like home construction, but also prevents their use in certain applications, for example in recreational vehicles (“RVs”). Specifically, wood composites like OSB are not often used in the construction of recreational vehicles (“RVs”), because their weight would reduce the available capacity for installing appliances and other amenities. But their high density offers more fundamental disadvantages as well. For example, the weight of OSB material is often the limiting factor for shipping and distributing material. For example, the trailers of trucks hauling the OSB material must leave with space on the trailer left unfilled because the maximum amount of weight that the trailer is allowed to carry has been reached.

And while performance characteristics such as strength and insulation properties of these wood-based composites are comparable or superior to natural solid wood lumber, some users have complained that in certain high-moisture environments, such as exterior siding, the edges of the composite material experience swelling and cracking as water penetrates into the edges of the material and causes it to expand.

Given the foregoing, there is a continuing need for a wood composite material that has at least comparable performance to solid wood lumber while being lighter (lower density) than conventional OSB materials. Additionally, this wood composite material would incorporate to some extent fibers harvested from tree species that are faster growing than those species which are conventionally used for wood composite materials.

### BRIEF SUMMARY OF THE INVENTION

The present invention relates to a wood composite board comprising albizzia strands.

The present invention relates to a wood composite board comprising albizzia strands, comprising: from about 1 wt % to about 100 wt % of the albizzia strands; from about 0 wt % to about 99 wt % wt % of strands of other wood species; and from about 1 wt % to about 20 wt % of polymeric binders; wherein the wood composite board has a density of about 23 lbs/ft³ to about 48 lbs/ft³.

### DETAILED DESCRIPTION OF THE INVENTION

All parts, percentages and ratios used herein are expressed by weight unless otherwise specified. All documents cited herein are incorporated by reference.

As used herein, “wood” is intended to mean a cellular structure, having cell walls composed of cellulose and hemicellulose fibers bonded together by lignin polymer. It should further be noted that the term “wood” encompasses lignocellulosic material generally.

By “wood composite material” it is meant a composite material that comprises wood and one or more wood composite additives, such as adhesives or waxes. The wood is typically in the form of veneers, flakes, strands, wafers, particles, and chips. Non-limiting examples of wood composite materials include oriented strand board (“OSB”), waferboard, particle board, chipboard, medium-density fiberboard, plywood, parallel strand lumber, oriented strand lumber, and laminated strand lumbers. Common characteristic of the wood composite materials are that they are composite materials comprised of strands and ply veneers binded with polymeric resin and other special additives. As used herein, “flakes”, “strands”, “chips”, “particles”, and “wafers” are considered equivalent to one another and are used interchangeably. A non-exclusive description of wood composite materials may be found in the Supplement Volume to the Kirk-Rothmer Encyclopedia of Chemical Technology, pp 765-810, 6^{th} Edition.

The present invention is directed to wood composite boards comprising albizzia strands. Albizzia as a material has many advantages over other wood materials typically used in wood composite boards. Most notably albizzia grows faster than other similar wood species. Furthermore albizzia has an excellent strength to weight ratio: being much less dense than other wood species.

The Albizzia is a group of quick-growing, flowering trees, native to Iran, Japan and other parts of Asia, but presently widely grown in the southern and western parts of the U.S. Commonly known species include A. Julibrissin, var. rosea, paraserianthes Fakcateria, A. lophantha, A. Kalkora, and A. Lebbek. A. Julibrissin, commonly known as Mimosa or Silk Tree, can reach a height of 30-40 feet or even as high as 80 feet. The foliage is feathery, resembling a fern's and their leaflets fold together at night. The 5- to 8-inch fluffy clusters of pink flowers are produced all summer long and are very attractive to hummingbirds.

The variety rosea of A. Julibrissin only grows from 15 to 20 feet high and has smaller clusters of darker pink flowers; it is also slightly more cold resistant. A. lophantha is the next hardiest. It will grow 10-12 feet tall, but can be kept much smaller by pruning every spring before new growth begins. The Albizzia species has lighter density than southern yellow pine by about one third.

In the present invention, it is preferred that the albizzia tree has reached an age of about six years before it is cut into logs and then stranded.

The boards or panels prepared according to the present invention may be made in the form of a variety of different materials, such as wood or wood composite materials, such as oriented strand board (“OSB”). In addition to albizzia, the wood composite or OSB panels may also incorporate strands from other wood species materials including naturally occurring hard or soft woods species, singularly or mixed; suitable other wood species in addition to albizzia include pine species such as loblolly pine, Virginia pine, slash pine, Short leaf pine, and long leaf pines, as well as Aspen or other hardwood species similar to Aspen wood. The wood boards of the present invention will include about 1 wt % to about 100 wt % albizzia wood, preferably about 1 wt % to about 99 wt % preferably about 50 wt % to about 95 wt %, more preferably about 70 wt % to about 90 wt %. Additionally, the wood boards also include about 0 wt % to about 99 wt % of strands of other wood species, preferably about 1 wt % to about 99 wt %.

Typically, the raw wood starting materials, either virgin or reclaimed, are cut into strands, wafers or flakes of desired size and shape, which are well known to one of ordinary skill in the art. The strands are preferably more than 2 inches long, more than 0.3 inch wide, and less than 0.5 inch thick. While not intended to be limited by theory, it is believed that longer strands, i.e., longer than about 6 inches, improves the final product mechanical strength by permitting better alignment. It is also known that uniform-width strands are preferred for better product quality. Uniform strand geometry allows a manufacturer to optimize the manufacturer's process for each size of strand. For instance, if all the stands were 4 inches×1 inch, then the orienter could be optimized to align those strands within a single layer. If strands that were 1 inch long and 0.25 inch wide were added, some of those could slide thru the orienters sideways. Cross-oriented strands lower the overall mechanical strength/stiffness of the product.

After the strands are cut they are dried in an oven to a moisture content of about 1 to 20%, preferably between 2 to 18%, more preferably from 5% to about 12%, and then coated with one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, a preferred technique is to spray the wax, resin and other additives upon the wood strands as the strands are tumbled in a drum blender.

After being coated and treated with the desired coating and treatment chemicals, these coated strands are used to form a multi-layered mat. In a conventional process for forming a multi-layered mat, the coated wood materials are spread on a conveyor belt in a series of two or more, preferably three layers. The strands are positioned on the conveyor belt as alternating layers where the “strands” in adjacent layers are oriented generally perpendicular to each other. It is understood by those skilled in the art that the products made from this process could have the strands aligned all in the same direction or randomly without a particular alignment.

Various polymeric resins, preferably thermosetting resins, may be employed as binders for the wood flakes or strands. Suitable polymeric binders include isocyanate resin, urea-formaldehyde, phenol formaldehyde, melamine-urea formaldehyde (“MUF”) and the co-polymers thereof. Isocyanates are the preferred binders, and preferably the isocyanates are selected from the diphenylmethane-p,p′-diisocyanate group of polymers, which have NCO— functional groups that can react with other organic groups to form polymer groups such as polyurea, —NCON—, and polyurethane, —NCOO—. 4,4-diphenyl-methane diisocyanate (“MDI”) is preferred. A suitable commercial pMDI product is Rubinate 1840 available from Huntsman/ICI, Salt Lake City, Utah, and Mondur 541 pMDI available from Bayer Corporation, North America, of Pittsburgh, Pa. Suitable commercial MUF binders are the LS 2358 and LS 2250 products from the Dynea corporation.

The binder concentration is preferably in the range of about 1.5 wt % to about 20 wt %, more preferably about 2 wt % to about 10 wt %. A wax additive is commonly employed to enhance the resistance of the OSB panels to moisture penetration. Preferred waxes are slack wax or an emulsion wax. The wax loading level is preferably in the range of about 0.5 to about 2.5 wt %.

After the multi-layered mats are formed according to the process discussed above, they are compressed under a hot press machine that fuses and binds together the wood materials to form consolidated OSB panels of various thickness and sizes. Preferably, the panels of the invention are pressed for 2-10 minutes at a temperature of about 100° C. to about 260° C. One particular consequence regarding the increased concentration of albizzia strands in a wood composite is that the wood composite material will be less dense. For example, OSB boards manufactured with pine typically have a density of around 42 lbs/ft³, while OSB board manufactured to be composed at least partly of albizzia strands have a density in the range of about 28 lbs lbs/ft³ to about 38 lbs/ft³. Of course, on the continuum between 100% non-albizzia and 100% albizzia, the higher the fraction of albizzia strands used in these mixed wood species composites the lower the density of the board or panel. The panel should have a thickness of about 0.6 cm (about ¼″) to about 10.2 cm (about 4″).

The invention will now be described in more detail with respect to the following, specific, non-limiting examples.

### EXAMPLES

Wood composite boards were prepared according to the present invention and according to the prior art in order to demonstrate the superior wood performance characteristics of wood boards incorporating albizzia as prepared according to the present invention.

Two Albizzia logs were obtained from Malaysia with the following properties, BDH (diameter at breast height) at 10.2 and 12.5 inches, tree height at 82.0 and 85.0 feet, about 9 years of growth, relatively straight. The logs were inspected, debarked and waferized shortly after arriving at the laboratory. The knife projection of the waferizer was set at 0.035″. Two pieces of fresh southern yellow pine logs collected from the normal OSB production plant stock were used as the control and underwent the same evaluation process. The flakes or strands were dried with a laboratory dryer. The target flake moisture content was about 4% when using liquid phenol-formaldehyde (PF) resin and 5% for MDI resin. The screening of the flakes was conducted with a laboratory screen shaker. The dried flakes were blended with 2% molten wax and different resin types and contents, i.e., 3% and 6% for liquid PF resin and 2.5% and 5% for MDI resin.

The liquid PF resin was GP3121 while MDI Rubinate 1840 was used as the MDI resin for all trial runs. After blending, flakes were formed in a 17×17″ oriented forming box into three-layer, cross-oriented mats. For each combination, three replicate samples were made. The mats were pressed with a 2″×2″ laboratory hot press at 400° F. for 210 seconds. The following pressing conditions were used for all trials: targeted thickness: 0.438″, platen temperature: 400° F., press cycle: 210 seconds, closing time: 20 seconds, degassing time: 40 to 60 seconds.

The average density of the OSB that contains albizzia was 33.1 lb/ft³. The average density of the OSB that contains southern yellow pine was 46.7 lb/ft³.

The parallel MOR of the OSBs were measured to be: 3850 to 5800 psi for Albizzia and 6600 to 9100 psi for southern yellow pine, perpendicular MOR of the OSBs were measured to be: 3400 to 4950 psi for Albizzia and 3100 to 5500 psi for southern yellow parallel MOE of OSBs were measured to be 750,000 to 1,200,000 psi for Albizzia and 1,100,000 to 1,370,000 psi for southern yellow pine, perpendicular MOE of OSBs were measured to be 400,000 to 690,000 psi for Albizzia and 350,000 to 580,000 psi for southern yellow pine.

Thus, as can be seen, the strength performance of albizzia-containing OSB is comparable to that of conventional wood pine OSB. At the same time, the albizzia-containing OSB was much lighter in weight than the pine OSB.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A wood composite board comprising albizzia strands.

2. The wood composite board according to claim 1, comprising from about 1 wt % to about 100 wt % of the albizzia strands.

3. The wood composite board according to claim 1, comprising from about 1 wt % to about 99 wt % of the albizzia strands, and about 99 wt % to about 1 wt % of strands of other wood species.

4. The wood composite board according to claim 1, wherein the wood composite board has a density of about 28 lbs/ft³ to about 38 lbs/ft³.

5. The wood composite board according to claim 1, wherein the wood composite board is in the form of an oriented strand board.

6. The wood composite board according to claim 1, wherein the wood composite comprises from about 1 wt % to about 20 wt % of polymeric binders.

7. A wood composite board comprising albizzia strands, comprising:
from about 1 wt % to about 99 wt % of the albizzia strands;
from about 1 wt % to about 99 wt % of strands of other wood species; and
from about 1 wt % to about 20 wt % of polymeric binders;
wherein the wood composite board has a density of about 28 lbs/ft³ to about 38 lbs/ft³.
